(19) United States
(12) Patent Application Publication
(10) Pub. No.: US 2009/0004446 A1
(43) Pub. Date: Jan. 1, 2009

(54) Portable, interactive folding annotation device for promoting deal-making in non-office settings

(75) Inventor: Robert Steven Jones, Evergreen, CO (US)

Correspondence Address: VESNA N. RAFATY, 18926 CAMPBELL ROAD, DALLAS, TX, 75252, US

(73) Assignee: DEALWORKS, LLC.

(21) Appl. No.: 12/206,002

(22) Filed: Sep. 8, 2008

Related U.S. Application Data
(63) Continuation-in-part of application No. 10/977,097, filed on Oct. 29, 2004, now abandoned.

(51) Int. Cl. B32B 33/00; G09F 23/10

(52) U.S. Cl. 428/211.1; 283/56; 40/124.09; 428/195.1

(57) ABSTRACT

An interactive, folding annotation device, method for promoting deal-making. An interactive folding device composed of substantially absorbent material comprising a plurality of panels sharing a folding junction for annotation thereon by a user who is an offeror, the device comprising a first panel comprising content substantially expressing the user's willingness to enter into a contract, a second panel comprising pre-printed content for prompting the user to responsively annotate terms of an offer, and a third panel comprising content for prompting the user to annotate thereon a date by which acceptance of the offer is sought, the personal delivery of the annotated device to a person constituting delivery of the offer to an offeree.

This application is a Continuation-in-part of application Ser. No. 10/977,097 filed on Oct. 29, 2004 which is hereby incorporated in full.

### BACKGROUND

In a mobile society, opportunities for individuals to initiate and conduct deal-making abound. While such deal-making activity is known, convenient and on-site accessible tools for promoting and teaching consummation and recordation of enforceable deals in such non-traditional settings is not known to the applicant.

The applicant herein discloses a portable, interactive device that is accessible to users in social settings such as but not limited to for example churches and wine-tasting gatherings which is designed to be a tool for prompting users to annotate information thereon that relates to subject matter of the purpose of the gathering. One possible embodiment of the disclosed device is a napkin. Napkins are commonplace items available at various public and private locations. The applicant is aware of so-called “pickup linens” as disclosed on Page 26 of the Winter 2007 issue of O at Home Magazine. Notwithstanding the preceding statement, the applicant hereby does not admit that reference as prior art as it post-dates the applicant's disclosure.

### SUMMARY OF THE INVENTION

The disclosed invention is directed to apparatus and method for promoting consummation of deals in non-office settings where traditional business office tools are not available. The concept behind the invention is to preserve the naturalness and spontaneity of the non-office setting while helping to promote recordation of potentially enforceable deals (if any) which may intentionally or spontaneously be conducted in the setting. The non-office settings anticipated are broadly places where people congregate for social activity and/or business and professional networking, professional education activity. Specific embodiments disclosed are tools which when properly annotated by users may be legally sufficient as promissory notes, option contracts for purchase/sale of real estate, receipts, assignments, merger and acquisition deals, licenses, sale of a business transactions, and formation of a business entity such as a partnership. The preferred embodiment of the disclosed device is a napkin which may be provided at various venues and which serves a dual purpose: napkin and annotation device. The interactive device is selectively pre-printed with pre-determined content which guides (as a user selectively unfolds successive panels of the device) a user through recordation of a contract which may ultimately be admissible as evidence of a binding agreement in a court of law. Thus, individuals who lack legal training may nevertheless successfully use the disclosed interactive device to document an agreement in such a way that it may be enforceable against the user and/or a third party. It is known that even legal professionals cannot recall all essential terms of a deal ‘on the fly’ in the spontaneity of deal-making discussions initiated and conducted in non-traditional business settings. The disclosed invention is suitable to create and evidence additional types of contracts not expressly noted herein and such embodiments are considered to be within the scope of the invention.

A second category of tools disclosed herein is directed to embodiments which are not directed to deal-making and are suitable instead for the convenient recordation of information in settings where note-taking is not traditional but is helpful.

The disclosed tool is suitable for use at business lunches, trade shows, professional seminars, wine tastings, country clubs, churches, restaurants, auctions, hospital rooms, and other informal settings where deals or business or legal transactions may be conducted and concluded. At wine tastings, for example, the disclosed device may be made available to encourage a taster to annotate his/her impressions of a wine. Per an embodiment of the disclosed WineKin™ (Trademark of DealWorks Group, LLC), pre-printed prompting content may include an identification of the wine (e.g., winery, vintage, vineyard, place of origin, price, etc), type of wine (e.g., white (e.g, Riesling, sauvignon blanc) red (Shiraz, cabernet sauvignon), blush/rose, dessert wine, taste attributes (bright, deep, spicy and adjectives further characterizing each type of taste) and an overall subjective taste rating (great, good, OK, not bad, ‘magnifique’, a score rating). The disclosed embodiment suitable for use at wine tastings may furthermore optionally be composed in part of litmus paper such that the user could use the device to test the acidity of the wine sample tasted. At hospitals or other settings, a user may document his/her last will and testament responsively to pre-printed content (i.e., pre-printed language indicating the user intends the device to be his last will and testament, a property listing, and the testator-user's signature and date) on device thereby creating a potentially enforceable will (in jurisdictions which accept that type of document).

Another feature of the disclosed tool is that it helps facilitate the progress of negotiations of complex deals in non-traditional business settings such as luncheons, dinners, golf courses. It is recognized that deals, especially complex deals, require more than a single meeting, conversation or negotiation. Examples of complex deals include mergers and acquisitions deals conducted by top executives of companies, a sale of a business entity and comprise numerous terms. The interactive folding device disclosed herein is accessible to users in non-traditional business settings and is used to capture and record progress of the negotiation in the non-traditional deal-making settings. When the parties return to the negotiation, they don't have the start from scratch to re-visit and renegotiate already-negotiated items thus facilitating progress of the deal-making. Back at the office, the disclosed annotated device may later be reduced to a formal agreement describing the deal. Per an embodiment of the disclosed device used to record progress of a complex merger/acquisition deal, pre-printed prompting content may include language relating to a listing of parties of interest to the deal, critical deal terms, an assets listing, investment needs, ownership splits, timeline for action items, an exit strategy and a deal sign-off.

A feature of one embodiment of the disclosed device is a napkin which has a surface area of one panel composed of a substantially non-absorbent material for the recordation thereon of the absolute final negotiated terms of a deal, including for example the purchase price for a piece of real estate, price and quantity for the purchase of goods, sharing ratios for partners in a new partnership. Alternatively, the last panel of the interactive device may be designated to be used to record the final negotiated terms such that the user's notations on the other panels of the device are deemed unenforceable and are merely records of a negotiation in progress. Alternatively, one specimen of the disclosed device may be annotated during the progress of a negotiation and another clean specimen of the device may then used to thereupon annotate the final negotiated terms of a deal. The latter specimen may optionally be offered in a special dedicated color such that users know that the specimen shall be used to record only the final negotiated terms of a contract. The ‘deal-in-progress’ specimen used to capture the progress of the negotiations may then be discarded as desired since the final deal has been captured in a separate clean specimen.

The disclosed interactive folding device may be embodied in traditional napkins such as a cocktail napkin or a dinner napkin each comprising its respective unique number of folds. Additional types of napkins of course are possible comprising a different number of folds and different shapes for the panels. Additionally, some panels of the disclosed interactive device may be kept devoid of printed content altogether to allow for “freeform” writing on the panel and to serve as a “scratch sheet” for the deal in progress. Such additional napkin configurations/styles are considered to be within the scope of the disclosed invention and within the grasp of a person of ordinary skill in the relevant design art. The term “initial folded state” as used herein refers to the folded state of the device as initially provided and presented for use. The disclosed interactive folding device may be made of an absorbent, disposable paper product or other materials such as linen, cotton or other fabric and including fabric blends.

I claim:

1. A portable, interactive folding device composed of substantially absorbent material for annotation thereon by a user, the annotated device sufficient as evidence of an enforceable contract binding at least the user of the device, the device comprising:
a first panel visible when the device is in an initial folded state, comprising pre-printed content substantially expressing language of a willingness to enter into the contract and
an interior panel sharing a folding junction with the first panel and comprising pre-printed content for prompting the user to annotate thereon an amount of money the user promises to pay for a value given to the user and the user's signature.

2. The device per claim 1 wherein the first panel further comprises pre-printed content substantially containing language indicating that the device is intended at least in part to be a promissory note.

3. The device per claim 1 wherein the device is a napkin.

4. An interactive folding device composed of substantially absorbent material for annotation thereon by a user, the annotated device sufficient as evidence of an enforceable contract binding at least the user of the device, the device comprising
a first panel visible when the device is in an initial folded state, comprising pre-printed content substantially expressing a willingness to enter into the contract and
one or more additional panels each sharing a folding junction with at least one of the first panel and each other, the panels collectively comprising pre-printed content for prompting the user to annotate thereon an option amount, term of option, a real property description, a purchase price, and signatures of the user and another person bound under the contract.

5. The device per claim 4 wherein the device is a napkin.

6. The device per claim 4 further comprising a panel with pre-printed content for prompting a signature by a witness to the contract where the witness is an individual who is neither the user nor a party bound under the contract.

7. An interactive folding device composed of substantially absorbent material, the device comprising a first folding panel visible when the device is in an initial folded state and a plurality of additional folding panels for annotation thereon by a user, the annotated device sufficient as evidence of a receipt of money consideration, the device comprising a panel comprising pre-printed prompting content for prompting the user to annotate thereon a money amount received by the user and the user's signature and date.

8. The device per claim 7 wherein the device is a napkin.

9. The device per claim 7 wherein the first panel comprises pre-printed content indicating that the device is intended at least in part as a receipt.

10. A portable, interactive folding device composed of substantially absorbent material comprising a plurality of panels sharing a folding junction for annotation thereon by a user who is an offeror, the device comprising a first panel comprising content substantially expressing the user's willingness to enter into a contract, a second panel comprising pre-printed content for prompting the user to responsively annotate terms of an offer, and a third panel comprising content for prompting the user to annotate thereon a date by which acceptance of the offer is sought, the personal delivery of the annotated device to a person constituting delivery of the offer to an offeree.

11. The device per claim 10 wherein the absorbent material is composed of a single color which is used to indicate that the annotated device is intended as evidence of an offer to a contract.

12. The device per claim 10 further comprising a third panel comprising pre-printed content substantially expressing language of acceptance of the offer and pre-printed content for prompting a signature by the offeree.

13. A method for promoting deal-making in a non-office settings the method comprising the steps of:
providing at the non-office setting an interactive folding device comprised of substantially absorbent material, the device comprising a plurality of folding panels sharing a folding junction, the first panel visible when the device is in an initial folded state and comprising pre-printed content substantially expressing at least a user's willingness to enter into a contract, the panels of the device collectively comprising pre-printed content for prompting the user to annotate thereon negotiated terms sufficient to constitute a binding contract between the user and another party, and
teaching use of the device at the non-office setting where the device is made available to users.

14. A napkin comprising pre-printed content for prompting a user to responsively annotate thereon responses relating to the user's subjective assessment of attributes of a wine consumed by the user at a wine-tasting event.

15. The napkin per claim 14 wherein the napkin is further composed in part of litmus paper for prompting the user to test an acidity of the wine.

16. An interactive folding device composed of substantially absorbent material comprising a plurality of folding panels comprising pre-printed content for prompting a user to responsively annotate thereon information relating to a prayer request originated by the user.

17. The device per claim 16 wherein the device is a napkin.

18. A portable interactive folding device composed of substantially absorbent material comprising a plurality of folding panels for annotation thereon by a user in response to pre-printed prompting content on the panels, the device comprising a first panel, visible when the device is in an initial folded state, comprising printed content substantially expressing language of willingness to enter into a deal, the device further comprising pre-printed content comprising language relating to a listing of parties of interest to a deal, critical deal terms, an assets listing, investment needs, ownership splits, timeline for action items, an exit strategy and a deal sign-off, the annotated device intended as a record of the deal binding at least the user.

19. The device per claim 18 wherein the device is a napkin.

20. An interactive folding device composed of a substantially absorbent material comprising a plurality of folding panels for annotation thereon by a user, the device comprising a first panel containing pre-printed content substantially expressing language that the user intends the device to be the user's last will and testament, additional panels collectively comprising pre-printed content prompting the user to responsively annotate thereon a property listing to be bequeathed, the user's signature, a date and a signature of at least one witness to the user's signature.
